(19) United States
(12) Patent Application Publication
(10) Pub. No.: US 2012/0243420 A1
(43) Pub. Date: Sep. 27, 2012

(54) Efficient Remote Call Diagnostics

(75) Inventors: Roy Antony Catterall, Riverton (AU); Allan Thomas Chandler, Daglish (AU); Mark Andrew Shewell, Perth (AU); Stephen James Yates, Beaconsfield (AU)

(73) Assignee: INTERNATIONAL BUSINESS MACHINES CORPORATION, Armonk, NY (US)

(21) Appl. No.: 13/052,957

(22) Filed: Mar. 21, 2011

(51) Int. Cl. H04L 12/26

(52) U.S. Cl. 370/242

(57) ABSTRACT

An approach is provided in which a request addressed to a remote target node is transmitted through a network path with the network path includeing multiple relay nodes. The transmitting system recognizes that the transmission of the first request failed. Relay nodes in the serial path are analyzed using historical failure data. A first relay node is identified as a likely failed relay node based on the analysis. The first relay node is tested by transmitting a test request to the likely failed relay node. If the transmission of the test request fails, the identified likely failed node is verified by testing the previous node in the path. If verification is successful, the first node is selected as the failing node. However, if verification is unsuccessful, then a second node is chosen as the likely failed node and testing resumes.

### BACKGROUND

The present disclosure relates to efficiently diagnosing remote calls between computer systems on a network. More particularly, the present disclosure relates to an approach of efficiently identifying nodes in a network path that are experiencing problems so that the node can be repaired and the path can be restored.

Calls from a client to a remote server make use of a variety of protocols, systems and applications. For a remote call to be successful, all components (or ‘nodes’) in the path from client to server have to be active, and configured correctly. Diagnosing problems associated with remote calls is therefore complex, and requires specific knowledge associated with each of the nodes that constitute the path from the client to the server. Because several nodes may be included in the path, identifying a failing node can be challenging and time consuming.

### BRIEF SUMMARY

According to one embodiment of the present invention, an approach is provided in which a request addressed to a remote target node is transmitted through a serial network path. The serial network path includes multiple relay nodes. When a reply is not received, the transmitting system recognizes that the transmission of the first request failed. One or more of the relay nodes in the serial path are analyzed using a set of historical failure data that pertain to the relay nodes. A first relay node is identified as a likely failed relay node based on the analysis and the first relay node is tested by transmitting a test request. If the transmission of the test request fails, the identified likely failed node is verified by identifying a previous node in the serial network path that sends signals to the identified likely failed node, transmitting a second test request to the previous node, and selecting the identified likely failed node as the failed relay node in response to receiving a response to the second test request from the previous node. However, if the transmission to the previous node fails, then a second relay node is identified as the likely failed node based on the analysis and the testing, detecting, and verification steps are performed on the second identified likely failed node in response to failing to receive the response to the second test request.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE SEVERAL VIEWS OF THE DRAWINGS

The present invention may be better understood, and its numerous objects, features, and advantages made apparent to those skilled in the art by referencing the accompanying drawings, wherein:

FIG. 1 is a block diagram of a data processing system in which the methods described herein can be implemented;

FIG. 2 provides an extension of the information handling system environment shown in FIG. 1 to illustrate that the methods described herein can be performed on a wide variety of information handling systems which operate in a networked environment;

FIG. 3 is a network path diagram depicting a multi-nodal path through which data is transmitted between a calling node and a remote target node;

FIG. 4 is a flowchart showing steps taken during a remote call test;

FIG. 5 is a flowchart showing steps taken in performing a historical failure analysis of nodes included in the network path; and

FIG. 6 is a flowchart showing steps taken in performing a binary split analysis used to identify a failing node in the network path.

### DETAILED DESCRIPTION

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

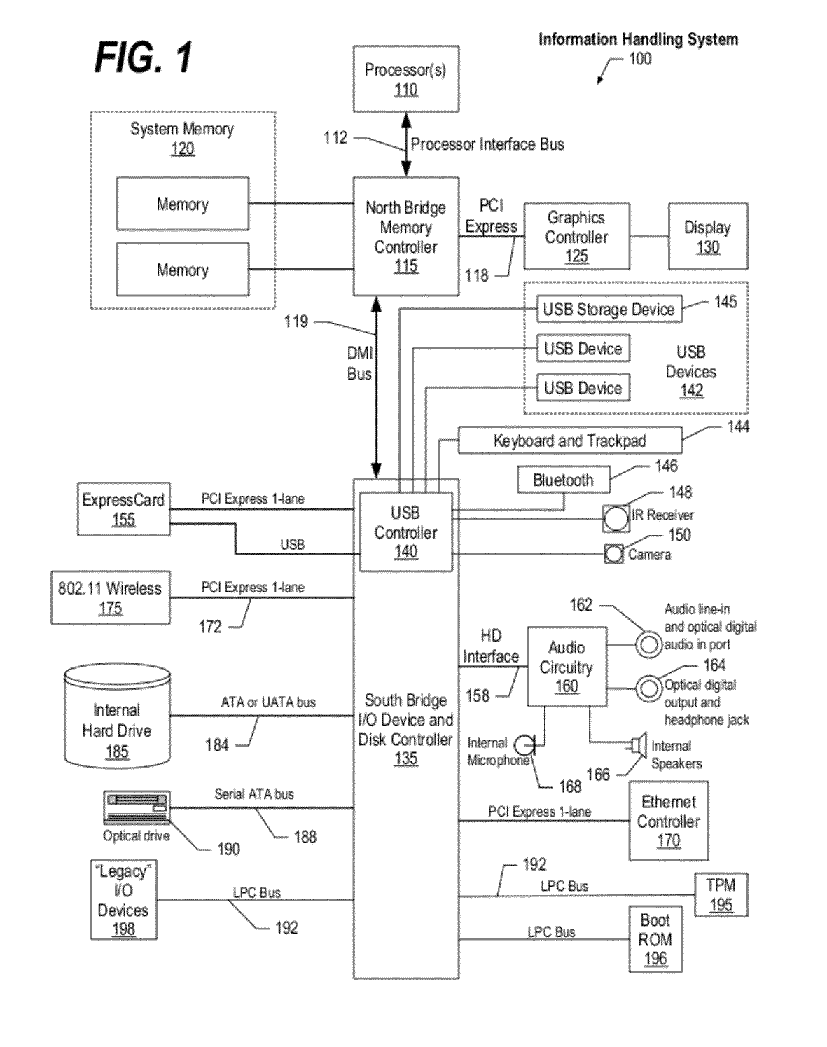

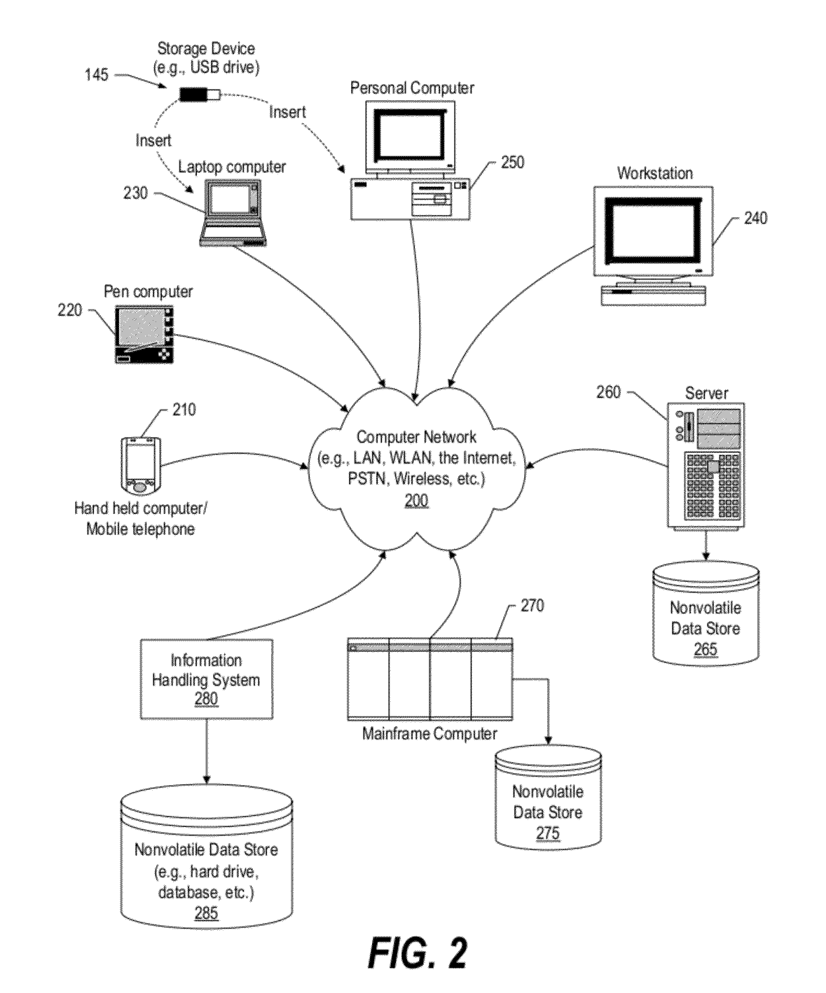

The following detailed description will generally follow the summary of the invention, as set forth above, further explaining and expanding the definitions of the various aspects and embodiments of the invention as necessary. To this end, this detailed description first sets forth a computing environment in FIG. 1 that is suitable to implement the software and/or hardware techniques associated with the invention. A networked environment is illustrated in FIG. 2 as an extension of the basic computing environment, to emphasize that modern computing techniques can be performed across multiple discrete devices.

FIG. 1 illustrates information handling system 100, which is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, PCI Express bus 118 connects Northbridge 115 to graphics controller 125. Graphics controller 125 connects to display device 130, such as a computer monitor.

Northbridge 115 and Southbridge 135 connect to each other using bus 119. In one embodiment, the bus is a Direct Media Interface (DMI) bus that transfers data at high speeds in each direction between Northbridge 115 and Southbridge 135. In another embodiment, a Peripheral Component Interconnect (PCI) bus connects the Northbridge and the Southbridge. Southbridge 135, also known as the I/O Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. The LPC bus also connects Southbridge 135 to Trusted Platform Module (TPM) 195. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and USB connectivity as it connects to Southbridge 135 using both the Universal Serial Bus (USB) the PCI Express bus. Southbridge 135 includes USB Controller 140 that provides USB connectivity to devices that connect to the USB. These devices include webcam (camera) 150, infrared (IR) receiver 148, keyboard and trackpad 144, and Bluetooth device 146, which provides for wireless personal area networks (PANs). USB Controller 140 also provides USB connectivity to other miscellaneous USB connected devices 142, such as a mouse, removable nonvolatile storage device 145, modems, network cards, ISDN connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (LAN) device 175 connects to Southbridge 135 via the PCI or PCI Express bus 172. LAN device 175 typically implements one of the IEEE 802.11 standards of over-the-air modulation techniques that all use the same protocol to wireless communicate between information handling system 100 and another computer system or device. Optical storage device 190 connects to Southbridge 135 using Serial ATA (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

The Trusted Platform Module (TPM 195) shown in FIG. 1 and described herein to provide security functions is but one example of a hardware security module (HSM). Therefore, the TPM described and claimed herein includes any type of HSM including, but not limited to, hardware security devices that conform to the Trusted Computing Groups (TCG) standard, and entitled “Trusted Platform Module (TPM) Specification Version 1.2.” The TPM is a hardware security subsystem that may be incorporated into any number of information handling systems, such as those outlined in FIG. 2.

FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as MP3 players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 2 depicts separate nonvolatile data stores (server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

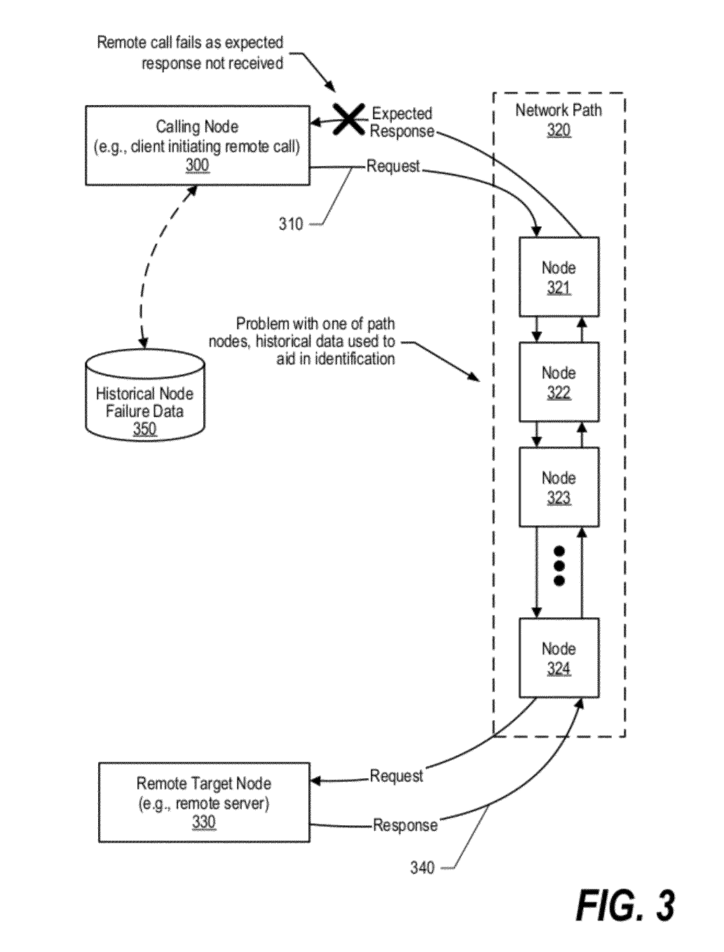

FIG. 3 is a network path diagram depicting a multi-nodal path through which data is transmitted between a calling node and a remote target node. Calling node 300, such as the initiator of a remote call from a remote client, transmits request 310 that is addressed to a remote target node, such as remote target node 330. The request flows through network path 320 which includes several relay nodes (e.g., relay nodes 321, 322, 323, 324, etc.) that receive the request either from the calling node (in the case of the first relay node, e.g., node 321, in the serial network path) or from a previous relay node in the path. Each relay node transmits the request to the next relay node in the path, or in the case of the last relay node, e.g., node 324, the request is transmitted from the last relay node to the remote target node (e.g., remote target node 330).

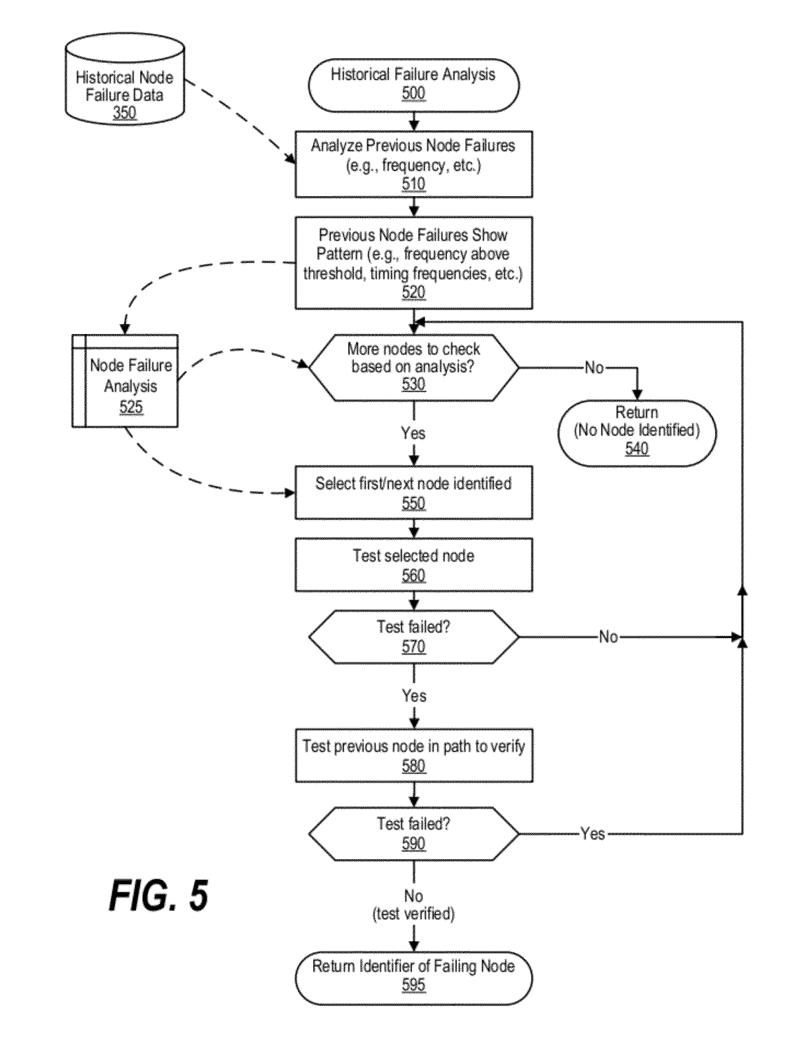

When remote target node 330, such as a remote server, etc., receives the request it acts on the request and transmits response 340 which is addressed back to calling node 300. In one embodiment, the transmission of response 340 back to calling node 300 follows the same network path 320 but in the reverse order (e.g., from relay node 324 to nodes 323, 322, 321, and finally back to calling node 300. However, if one of the relay nodes is not performing correctly (a failed relay node), the failure can cause the failed relay node to cease relaying data (requests and responses) as outlined above. When this occurs, calling node 300 will not receive the expected response (e.g., the response will not be received within a given timeout interval). A computer system, such as calling node 300, then diagnoses network path 320 by analyzing the relay nodes included in network path 320. In one embodiment, the analysis utilizes historical failure data 350 that pertains to the various nodes that are included in network path 320. As the name implies, historical failure data 350 includes a record of past failures that have occurred with the various relay nodes. A result of the analysis may reveal that a particular relay node has been experiencing a high level of failures (an identified likely failed node). The diagnostic routine can then test this likely failed relay node to determine whether it is the relay node that is currently failing (the failed relay node) irregardless of the likely failed relay node's position in network path 320. If the likely failed relay node is determined to be the failed relay node then corrective remedies can be applied to the failed relay node (e.g., rebooting the failed node, etc.) to correct the failure. On the other hand, if the likely failed relay node is tested and determined to be working (not failing), then analysis of the historical failure data can be used to identify other likely failed relay nodes based on past failure incidents and these likely failed relay nodes can be tested in order to identify the failed relay node. For detailed steps utilized in the historical node failure analysis see FIG. 5 and corresponding text.

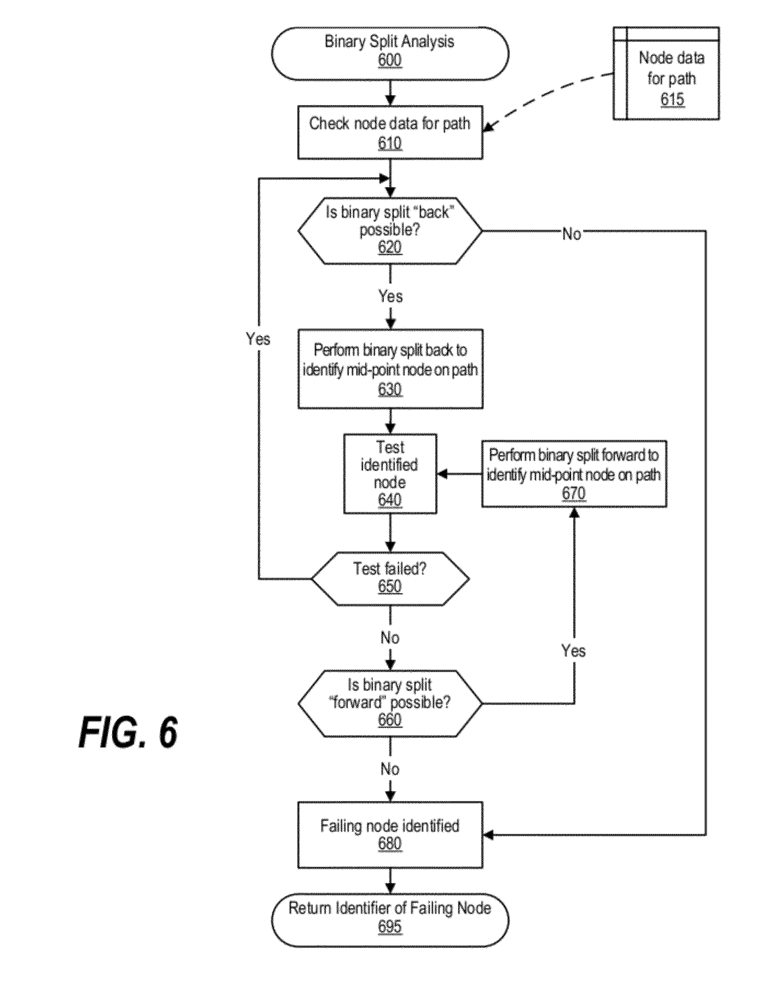

In one embodiment, if analysis of historical failure data 350 does not reveal the failed relay node (e.g., historical node failure data does not include enough failure data for proper analysis, all likely failed relay nodes have been tested and found to be working, etc.), then a binary-split analysis is performed to identify the failed relay node. The binary-split analysis works utilizes a binary search-type algorithm to select a mid-point relay node, test the mid-point node and move either forward or back in the chain of relay nodes finding a new mid-point node and testing the new mid-point node. This is recursively performed until the failed node is identified. For detailed steps utilized in the binary-split analysis see FIG. 6 and corresponding text.

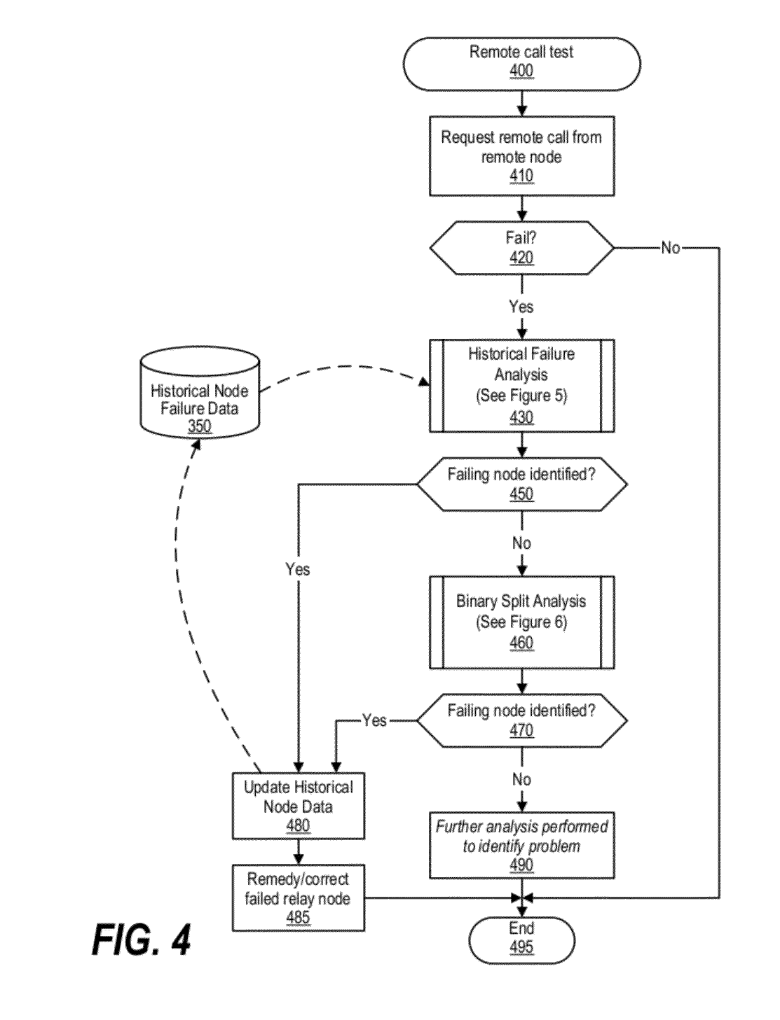

FIG. 4 is a flowchart showing steps taken during a remote call test. Processing commences at 400 whereupon, at step 410, a request is made and transmitted to a remote target node. A decision is made as to whether the request failed (decision 420, e.g., when a response is not received from the remote target node within a given period of time). If the request did not fail (a response was received from the remote target node), then decision 420 branches to the “no” branch bypassing the remaining steps. On the other hand, if the remote call failed, then decision 420 branches to the “yes” branch whereupon, at predefined process 430, historical failure analysis is performed utilizing historical node failure data 350 which is retrieved from a data store (see FIG. 5 and corresponding text for processing details). A decision is made as to whether the historical failure analysis was able to identify the failed relay node (decision 450). If the historical failure analysis identified the failed relay node, then decision 450 branches to the “yes” branch whereupon, at step 480, the historical node failure data is updated with the data pertaining to the current failed node and, at step 485, action is taken to remedy and/or correct the failed relay node, such as rebooting the relay node, etc.

Returning to decision 450, if the historical failure analysis was unable to identify the failed relay node, then decision 450 branches to the “no” branch whereupon, at predefined process 460, a binary split analysis is performed in order to identify the failed relay node (see FIG. 6 and corresponding text for processing details). If the binary split analysis was able to identify the failed relay node, then decision 470 branches to the “yes” branch whereupon, at step 480, the historical node failure data is updated with the data pertaining to the current failed node identified by the binary split analysis and, at step 485, action is taken to remedy and/or correct the failed relay node, such as rebooting the relay node, etc. Returning to decision 470, if the binary split analysis was unable to identify the failed relay node, then decision 470 branches to the “no” branch whereupon, at step 490, technicians and other knowledge workers are dispatched to identify the problem that is occurring (e.g., bad wiring, failure with calling node or target node, etc.). Processing thereafter ends at 495.

FIG. 5 is a flowchart showing steps taken in performing a historical failure analysis of nodes included in the network path. This routine is called at predefined process 430 shown in FIG. 4. Processing of the historical failure analysis commences at 500 whereupon, at step 510 an analysis is performed of previous relay node failures pertaining to the relay nodes that are included in the serial network path between the requesting node and the remote target node. The historical node failure data is read from data store 350 and processed using failure analysis that identifies relay nodes that more frequently fail. In addition, the failure analysis may weight failures so that failures that occur more recently are weighted heavier than failures that occurred longer ago in the past. At step 520, the relay node failure analysis completes and develops a failure analysis stored in memory area 525 that identifies, and in one embodiment ranks, likely failed relay nodes so that the relay node that most likely failed is ordered at the top and is tested first before nodes that are less likely to have failed.

A decision is made as to whether the node failure analysis identified any likely failed nodes (decision 530). If the analysis did not identify any likely failed relay node, then decision 530 branches to the “no” branch whereupon, at 540, processing returns to the calling routine (see FIG. 4) with an indication that the failed node was not identified by the historical failure analysis routine. On the other hand, if one or more relay nodes were identified as likely failed nodes based on the analysis, then decision 530 branches to the “yes” branch to process these nodes.

At step 550, the first node (e.g., most likely to have failed) identified by the analysis is selected. At step 560, the selected node is tested by sending a test request to the selected (likely failed) relay node. A decision is made as to whether the test failed (decision 570) based on whether a response was received from the request. If the test did not fail (a response was received from the selected node), then decision 570 branches to the “no” branch which loops back to determine if there are additional “likely failed” nodes identified by the historical failure analysis that need to be tested. On the other hand, if the test failed, then decision 570 branches to the “yes” branch whereupon, at step 580, the previous node in the serial network path is tested by sending a request to the previous node. The previous node is the node in the serial network path that directly relays requests to the selected node. A decision is made as to whether the test to the previous node also failed (decision 590) based on whether a response was received from the request. If the test did not fail (a response was received from the selected node), then decision 590 branches to the “no” branch whereupon, at 595, processing returns to the calling routine (see FIG. 4) with the identifier of the failed relay node. Because the test to the previous node was successful but the test to the likely failed node was unsuccessful, the likely failed node has been verified as being the failed node.

On the other hand, if the test with the previous node failed (a response was not received from the previous node), then decision 590 branches to the “yes” branch which loops back to determine if there are additional “likely failed” nodes identified by the historical failure analysis that need to be tested. Processing keeps looping back until either the failed node is identified (with processing returning at 595) or until there are no more relay nodes to check based on the historical failure analysis, at which point decision 530 branches to the “no” branch and processing returns to the calling routine (see FIG. 4) with an indication that the failed node was not identified by the historical failure analysis routine.

FIG. 6 is a flowchart showing steps taken in performing a binary split analysis used to identify a failing node in the network path. This routine is called at predefined process 460 shown in FIG. 4. Processing of the binary split analysis commences at 600 whereupon, at step 610, node data is checked by reading the node data for the path from memory area 615. The node failure data includes the order of relay nodes that encompass the serial network path used to connect the calling node with the remote target node.

A decision is made as to whether a binary split back is possible between the calling node and the remote target node (decision 620). Since this is the first run through the algorithm, a binary split back should be possible so that decision 620 branches to the “yes” branch whereupon, at step 630, a binary split back is performed to identify the mid-point relay node on the path between the calling node an the remote target node (e.g., roughly half of the relay nodes being between the calling node and the mid-point node and the other half being between the mid-point node and the remote target node). At step 640, the identified mid-point node is tested by sending a request to the identified mid-point node. A decision is made as to whether the test to the current mid-point node failed (decision 650). If the decision failed (indicating that the failed node is somewhere between the calling node and the current mid-point node), then decision 650 branches to the “yes” branch which loops back and determines if another binary split back is possible, this time between the calling node and the current mid-point node. If a split back is not possible, then decision 620 branches to the “no” branch whereupon, at step 680, the failed node is identified as being the current mid-point node and at 695 processing returns to the calling routine (see FIG. 4) with the identifier of the failed relay node (the current mid-point node). If a split back is possible, then decision 620 branches to the “yes” branch whereupon, at step 630, another binary split is performed this time between the calling node and the current mid-point node to identify a new mid-point node which is tested as described above.

Returning to decision 650, if the test of the current mid-point node does not fail, the test indicates that the failed node lies after the current mid-point node and before the remote target node. In this case, decision 650 branches to the “no” branch whereupon a decision is made as to whether a binary split forward is possible (e.g., a binary split between the current mid-point node and the remote target node so that roughly half of the relay nodes between these nodes are positioned before the new mid-point node and roughly half of the relay nodes between these nodes are positioned after the new mid-point node. If a binary split forward is possible, then decision 660 branches to the “yes” branch whereupon, at step 670, the binary split forward is calculated as described above and processing loops back to step 640 which tests the newly identified mid-point node. Once again, if the test fails, then decision 650 branches to the “yes” branch which loops back to determine if a binary split backward is possible and proceeds accordingly as outlined above.

Returning to decision 660, if a binary split forward is not possible, then decision 620 branches to the “no” branch whereupon, at step 680, the failed node is identified as being the current mid-point node and processing returns at 695 to the calling routine (see FIG. 4) with the identifier of the failed relay node (the current mid-point node).

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

1. A computer-implemented method comprising:
transmitting a request addressed to a remote target node through a serial network path using a network adapter, wherein the serial network path includes a plurality of relay nodes;
recognizing that the transmission of the first request failed, wherein the failure is due to a failed relay node;
analyzing one or more of the plurality of relay nodes using a set of historical failure data pertaining to the plurality of relay nodes;
identifying a first of the plurality of relay nodes as a likely failed relay node based on the analysis;
testing the identified likely failed relay node by transmitting a first test request to the likely failed relay node;
detecting that the transmission of the test request failed;
verifying the identified likely failed node by:
identifying a previous node in the serial network path that sends signals to the identified likely failed node;
transmitting a second test request to the previous node;
identifying the identified likely failed node as the failed relay node in response to receiving a response to the second test request; and
identifying a second of the plurality of relay nodes as the likely failed node based on the analysis and performing the testing, detecting, and verification steps on the second identified likely failed node in response to failing to receive the response to the second test request.

2. The method of claim 1 further comprising:
updating the set of historical failure data with the identified failed relay node.

3. The method of claim 1 further comprising:
analyzing one or more of the plurality of relay nodes using a binary split analysis, wherein the binary split analysis further comprises:
identifying a first mid-point relay node in the serial network path;
testing the first mid-point relay node by transmitting a first binary split test request to the identified first mid-point relay node;
in response to the transmission of the first binary split test request failing:
determining whether a binary split back is available to identify a second mid-point relay node;
performing the binary split back to identify the second mid-point relay node in response to the determination being that the binary split back is available; and
selecting the first mid-point relay node as the failed relay node in response to the determination being that the binary split back is unavailable;
in response to the transmission of the first binary split test request succeeding:
determining whether a binary split forward is available to identify the second mid-point relay node;
performing the binary split forward to identify the second mid-point relay node in response to the determination being that the binary split forward is available; and
selecting the first mid-point relay node as the failed relay node in response to the determination being that the binary split forward is unavailable;
wherein the identification of one or more additional mid-point nodes is performed using the testing and identification steps until the failed relay node is selected.

4. The method of claim 3 wherein the binary split analysis is performed in response to the historical failure data analysis failing to identify the failed relay node.

5. The method of claim 3 further comprising:
updating the set of historical failure data with the identified failed relay node.

6. The method of claim 1 wherein the recognizing that the transmission of the first request failed further comprises:
setting a timeout interval; and
identifying that a response to the first request was not received before the timeout interval has elapsed.

7. The method of claim 1 wherein the historical failure analysis data includes a record of past failures corresponding each of the plurality of relay nodes that has failed over a period of time.

8. An information handling system comprising:
one or more processors;
a memory coupled to at least one of the processors;
a set of computer program instructions stored in the memory and executed by at least one of the processors in order to perform actions of:
transmitting a request addressed to a remote target node through a serial network path, wherein the serial network path includes a plurality of relay nodes;
recognizing that the transmission of the first request failed, wherein the failure is due to a failed relay node;
analyzing one or more of the plurality of relay nodes using a set of historical failure data pertaining to the plurality of relay nodes;
identifying a first of the plurality of relay nodes as a likely failed relay node based on the analysis;
testing the identified likely failed relay node by transmitting a first test request to the likely failed relay node;
detecting that the transmission of the test request failed;
verifying the identified likely failed node by:
identifying a previous node in the serial network path that sends signals to the identified likely failed node;
transmitting a second test request to the previous node;
identifying the identified likely failed node as the failed relay node in response to receiving a response to the second test request; and
identifying a second of the plurality of relay nodes as the likely failed node based on the analysis and performing the testing, detecting, and verification steps on the second identified likely failed node in response to failing to receive the response to the second test request.

9. The information handling system of claim 8 wherein the processors perform additional actions comprising:
updating the set of historical failure data with the identified failed relay node.

10. The information handling system of claim 8 wherein the processors perform additional actions comprising:
analyzing one or more of the plurality of relay nodes using a binary split analysis, wherein the binary split analysis further comprises:
identifying a first mid-point relay node in the serial network path;
testing the first mid-point relay node by transmitting a first binary split test request to the identified first mid-point relay node;
in response to the transmission of the first binary split test request failing:
determining whether a binary split back is available to identify a second mid-point relay node;
performing the binary split back to identify the second mid-point relay node in response to the determination being that the binary split back is available; and
selecting the first mid-point relay node as the failed relay node in response to the determination being that the binary split back is unavailable;
in response to the transmission of the first binary split test request succeeding:
determining whether a binary split forward is available to identify the second mid-point relay node;
performing the binary split forward to identify the second mid-point relay node in response to the determination being that the binary split forward is available; and
selecting the first mid-point relay node as the failed relay node in response to the determination being that the binary split forward is unavailable;
wherein the identification of one or more additional mid-point nodes is performed using the testing and identification steps until the failed relay node is selected.

11. The information handling system of claim 10 wherein the binary split analysis is performed in response to the historical failure data analysis failing to identify the failed relay node.

12. The information handling system of claim 10 wherein the processors perform additional actions comprising:
updating the set of historical failure data with the identified failed relay node.

13. The information handling system of claim 1 wherein the historical failure analysis data includes a record of past failures corresponding each of the plurality of relay nodes that has failed over a period of time.

14. A computer program product stored in a computer readable storage medium, comprising computer program code that, when executed by an information handling system, causes the information handling system to perform actions comprising:
transmitting a request addressed to a remote target node through a serial network path using a network adapter, wherein the serial network path includes a plurality of relay nodes;
recognizing that the transmission of the first request failed, wherein the failure is due to a failed relay node;
analyzing one or more of the plurality of relay nodes using a set of historical failure data pertaining to the plurality of relay nodes;
identifying a first of the plurality of relay nodes as a likely failed relay node based on the analysis;
testing the identified likely failed relay node by transmitting a first test request to the likely failed relay node;
detecting that the transmission of the test request failed;
verifying the identified likely failed node by:
identifying a previous node in the serial network path that sends signals to the identified likely failed node;
transmitting a second test request to the previous node;
identifying the identified likely failed node as the failed relay node in response to receiving a response to the second test request; and
identifying a second of the plurality of relay nodes as the likely failed node based on the analysis and performing the testing, detecting, and verification steps on the second identified likely failed node in response to failing to receive the response to the second test request.

15. The computer program product of claim 14 wherein the information handling system performs further actions comprising:
updating the set of historical failure data with the identified failed relay node.

16. The computer program product of claim 14 wherein the information handling system performs further actions comprising:
analyzing one or more of the plurality of relay nodes using a binary split analysis, wherein the binary split analysis further comprises:
identifying a first mid-point relay node in the serial network path;
testing the first mid-point relay node by transmitting a first binary split test request to the identified first mid-point relay node;
in response to the transmission of the first binary split test request failing:
determining whether a binary split back is available to identify a second mid-point relay node;
performing the binary split back to identify the second mid-point relay node in response to the determination being that the binary split back is available; and
selecting the first mid-point relay node as the failed relay node in response to the determination being that the binary split back is unavailable;
in response to the transmission of the first binary split test request succeeding:
determining whether a binary split forward is available to identify the second mid-point relay node;
performing the binary split forward to identify the second mid-point relay node in response to the determination being that the binary split forward is available; and
selecting the first mid-point relay node as the failed relay node in response to the determination being that the binary split forward is unavailable;
wherein the identification of one or more additional mid-point nodes is performed using the testing and identification steps until the failed relay node is selected.

17. The computer program product of claim 16 wherein the binary split analysis is performed in response to the historical failure data analysis failing to identify the failed relay node.

18. The computer program product of claim 16 wherein the information handling system performs further actions comprising:
updating the set of historical failure data with the identified failed relay node.

19. The computer program product of claim 14 wherein the recognizing that the transmission of the first request failed further comprises:
setting a timeout interval; and
identifying that a response to the first request was not received before the timeout interval has elapsed.

20. The method of claim 1 wherein the historical failure analysis data includes a record of past failures corresponding each of the plurality of relay nodes that has failed over a period of time.
